(19) United States
(12) Patent Application Publication
(10) Pub. No.: US 2005/0263613 A1
(43) Pub. Date: Dec. 1, 2005

(54) Multiple reservoir apparatus and methods therefor

(76) Inventors: Hazel D. Beck, Kingman, AZ (US); Diane J. Grimes, Kingman, AZ (US)

Correspondence Address: WEISS & MOY PC, 4204 NORTH BROWN AVENUE, SCOTTSDALE, AZ, 85251, US

(21) Appl. No.: 10/845,325

(22) Filed: May 14, 2004

(51) Int. Cl. B05B 9/01

(52) U.S. Cl. 239/304; 239/525; 239/526; 239/303; 239/305; 239/345; 239/379; 239/407

(57) ABSTRACT

A combination multiple reservoir and spray gun assembly comprises a multiple reservoir apparatus and a spray gun. The multiple reservoir apparatus comprises a fluid conduit and a plurality of reservoirs. Each one of the plurality of reservoirs is coupled in fluid communication to an interior portion of the fluid conduit and a spray gun is coupled to a fluid output portion of the fluid conduit for dispensing a spray fluid. The combination multiple reservoir and spray gun assembly further comprises at least one valve and the at least one valve facilitates flow of the fluid at a predetermined rate from each one of the plurality of reservoirs to the spray gun. A person manually adjusts the at least one valve and selectively distributes at least one fluid from the plurality of reservoirs to the fluid conduit. Alternatively, a controller automatically adjusts the at least one valve.

### FIELD OF THE INVENTION

This invention relates generally to apparatus for spray painting and more specifically to improved multiple reservoir apparatus and combination multiple reservoir and spray gun assemblies and methods therefor for more efficiently applying a variety of paints and primers to at least one surface of an object.

### BACKGROUND OF THE INVENTION

In the past, after the repair of damaged panels of vehicles, the damaged panels have been spray painted with several coatings of primers followed by paints. Usually, this has been a time-consuming operation requiring one primer loaded into a reservoir coupled to a spray gun and gravity feeding the primer into the spray gun. After completing the priming operation, the reservoir is cleaned out and paint is loaded into the reservoir, so that multiple coatings of the paint may be sprayed. Besides being time consuming, these operations are somewhat wasteful of materials.

Various re-circulating paint systems with multiple feed lines coupled to a spray gun are known. However, these systems require re-circulating pumps to drive the paint to the spray gun. A gravity-fed system is simpler, less expensive and less likely to encounter mechanical difficulties, plus requiring less power to operate. To date no gravity-fed apparatus having multiple reservoirs coupled to a spray gun has been disclosed.

While a gravity-fed apparatus having multiple reservoirs coupled to a spray gun is particularly useful for spray painting vehicle panels, many other applications have similar needs. One example is an air-brush such as used for decorating cakes. Once again, in order to spray paint the surface of a cake, usually a single cup is coupled to the air brush, so that only a single paint may be dispensed. After spraying the first paint, the cup needs to be cleared of the paint and a new paint is loaded into the cup, and the operation is repeated until all spraying operations are complete. This is a time-consuming procedure. Yet another similar application is the spray painting of boats. In addition to painting the boat often a clear lacquer is also applied. Once again, using a single reservoir apparatus makes such an application time-consuming and results in wasting of materials.

The present inventors have recognized the need for an improved gravity-fed apparatus for a spray gun and more particularly for improved and economical combination multiple reservoir apparatus and spray gun assemblies and to also provide various embodiments of such improved multiple reservoir apparatus coupled to a spray gun and methods therefor.

### SUMMARY OF THE INVENTION

Accordingly, it is an object of this disclosure to provide improved gravity-fed apparatus for a spray gun.

It is a further object of this disclosure to provide improved combination multiple reservoir apparatus and spray gun assemblies.

It is a still further object of this disclosure to provide methods for using improved gravity-fed apparatus for a spray gun to apply paint to at least one surface of an object.

It is a yet further object of this disclosure to provide methods for using improved combination multiple reservoir apparatus and spray gun assemblies to apply paint to at least one surface of an object.

### PREFERRED EMBODIMENTS OF THE INVENTION

In accordance with one embodiment of this invention, a combination multiple reservoir and spray gun assembly comprises in combination, a multiple reservoir apparatus comprising a substantially hollow elongated fluid conduit and a plurality of reservoirs each coupled in fluid communication to an interior portion of the fluid conduit and a spray gun coupled to a fluid output portion of the fluid conduit for dispensing a spray fluid. At least one valve is coupled to a portion of the multiple reservoir apparatus thereby facilitating flow of the fluid at a predetermined rate from each one of the plurality of reservoirs to the spray gun. At least one controller may be coupled to the at least one valve of the multiple reservoir apparatus and the at least one controller is adapted to automatically feed a predefined quantity of at least one of a plurality of fluids from each one of the plurality of reservoirs to the spray gun at a predetermined flow rate.

In accordance with a second embodiment of this invention, a multiple reservoir apparatus for a spray gun comprises in combination a substantially hollow elongated fluid conduit. Each one of a plurality of reservoirs provides a fluid for gravity feeding the fluid to the fluid conduit. The spray gun is coupled to a fluid output portion of the fluid conduit for dispensing a spray fluid and the spray gun receives the fluid that is gravity fed into the fluid conduit from the plurality of reservoirs.

In accordance with a third embodiment of this invention, a method for using a combination multiple reservoir and spray gun assembly comprises the steps of providing a multiple reservoir apparatus comprising a substantially hollow elongated fluid conduit and a plurality of reservoirs, each one of the plurality of reservoirs being coupled in fluid communication to an interior portion of the fluid conduit and providing a spray gun coupled to a fluid output portion of the fluid conduit, the fluid conduit for dispensing a spray fluid. The method further comprises the steps of providing at least one valve coupled to a portion of the multiple reservoir apparatus, the at least one valve facilitating flow of the fluid at a predetermined rate from each one of the plurality of reservoirs to the spray gun; providing the at least one valve is coupled to a portion of the fluid conduit; and providing a plurality of connectors coupled to a portion of the fluid conduit, each one of the plurality of connectors sized to receive one reservoir of the plurality of reservoirs. The method further comprises the steps of adjusting the at least one valve; and selectively distributing at least one fluid from at least one of the plurality of reservoirs to the fluid conduit.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

FIG. 1 is a perspective view of one embodiment of a combination multiple reservoir and spray gun assembly showing one reservoir coupled to an elongated fluid conduit of the combination multiple reservoir and spray gun assembly and a second reservoir (shown in dotted lines) coupled to the elongated fluid conduit of the combination multiple reservoir and spray gun assembly according to the present invention.

FIG. 2 is a perspective view showing a front side of one embodiment of a multiple reservoir apparatus with a spray gun adaptor coupled to an elongated fluid conduit for coupling the multiple reservoir apparatus to a portion of a spray gun, a first male connector coupled to a portion of the elongated fluid conduit for receiving a first reservoir (not shown), a second male connector coupled to a portion of the elongated fluid conduit for receiving a second reservoir (not shown), and a first valve coupled to a portion of the elongated fluid conduit of the multiple reservoir apparatus and a second valve coupled to a portion of the elongated fluid conduit of the multiple reservoir apparatus, the first valve adapted to receive a first fluid (not shown) from the first reservoir and the second valve adapted to receive a second fluid (not shown) from the second reservoir.

FIG. 3 is a sectional view through 3-3 of the multiple reservoir apparatus of FIG. 2 showing one valve stem inserted in a portion of a valve coupled to a portion of a substantially hollow elongated fluid conduit for fluid communication with at least one reservoir (not shown).

FIG. 4 is a perspective view showing a front side of a portion of another embodiment of a multiple reservoir apparatus with a spray gun adaptor coupled to a portion of an elongated fluid conduit for coupling the multiple reservoir apparatus to a portion of a spray gun, a female connector coupled to a portion of the elongated fluid conduit for receiving a reservoir (not shown) and one valve coupled to a portion of the elongated fluid conduit of the multiple reservoir apparatus adapted to receive a fluid (not shown) from the reservoir.

FIG. 5 is a perspective view showing a front side of yet another embodiment of a multiple reservoir apparatus with an elongated fluid conduit having a first end and a second end, a spray gun adaptor coupled to a portion of the elongated fluid conduit for coupl portion of a spray gun, a first male connector coupled to a portion of the elongated fluid conduit for receiving a first reservoir (not shown), a second male connector coupled to a portion of the elongated fluid conduit for receiving a second reservoir (not shown), and a first valve coupled to the first end of the elongated fluid conduit of the multiple reservoir apparatus and a second valve coupled to the second end of the elongated fluid conduit of the multiple reservoir apparatus, the first valve adapted to receive a first fluid (not shown) from the first reservoir and the second valve adapted to receive a second fluid (not shown) from the second reservoir.

FIG. 6 is a perspective view showing a front side of still another embodiment of a multiple reservoir apparatus with an elongated fluid conduit, a spray gun adaptor coupled to a portion of the elongated fluid conduit for coupling the multiple reservoir apparatus to a portion of a spray gun, a first male connector coupled to a portion of the elongated fluid conduit for receiving a first reservoir (not shown), a second male connector coupled to a portion of the elongated fluid conduit for receiving a second reservoir (not shown), and a valve coupled to a portion of the elongated fluid conduit of the multiple reservoir apparatus adapted to receive a first fluid (not shown) from the first reservoir and a second fluid (not shown) from the second reservoir.

FIG. 7 is a perspective view showing a front side of yet another embodiment of a multiple reservoir apparatus with a spray gun adaptor coupled to an elongated fluid conduit for coupling the multiple reservoir apparatus to a portion of a spray gun, a multiplicity of connectors, each one of the multiplicity of connectors coupled to a portion of the elongated fluid conduit for receiving a multiplicity of reservoirs (two shown), and a multiplicity of valves, each one of the multiplicity of valves coupled to a portion of the elongated fluid conduit of the multiple reservoir apparatus, each one of the multiplicity of valves adapted to receive a fluid (not shown) from each one of the multiplicity of reservoirs.

FIG. 8 is a perspective view showing a front side of one embodiment of a multiple reservoir apparatus with a spray gun adaptor coupled to an elongated fluid conduit for coupling the multiple reservoir apparatus to a portion of a spray gun, a first connector coupled to a portion of the elongated fluid conduit for receiving a first reservoir and a second connector coupled to a portion of the elongated fluid conduit for receiving a larger second reservoir.

FIG. 9 is a perspective view of another embodiment of a combination multiple reservoir and spray gun assembly showing a first male connector coupled to a portion of an elongated fluid conduit for receiving a first reservoir, a second male connector coupled to a portion of the elongated fluid conduit for receiving a second reservoir, a first valve coupled to a portion of the elongated fluid conduit of the multiple reservoir apparatus and a second valve coupled to a portion of the elongated fluid conduit of the multiple reservoir apparatus, the first valve adapted to receive a first fluid (not shown) from the first reservoir and the second valve adapted to receive a second fluid (not shown) from the second reservoir, and with a controller coupled to both the first valve and the second valve adapted to automatically feed a predefined quantity of the first fluid from the first reservoir and of the second fluid from the second reservoir.

### DESCRIPTION OF THE INVENTION

According to FIG. 1, in one embodiment of a combination multiple reservoir and spray gun assembly 100, the combination multiple reservoir and spray gun assembly 100 comprises a multiple reservoir apparatus 10 and a spray gun 30. The multiple reservoir apparatus 10 gravity feeds at least one of a plurality of fluids to the spray gun 30. The multiple reservoir apparatus 10 further comprises a substantially hollow elongated fluid conduit 12 and a plurality of reservoirs 14 (two reservoirs 14 shown in FIG. 1) each coupled in fluid communication to an interior portion (not shown in FIG. 1, but partially shown in FIG. 3) of the fluid conduit 12. The spray gun 30 is coupled to a spray gun adaptor 16 which is further coupled to a fluid output portion 32 of the fluid conduit 12 for dispensing a spray fluid (not shown). It is to be understood that the multiple reservoir apparatus 10 may comprise more than two reservoirs 14. It is also understood that the spray gun 30 may be an air-brush, an aerosol dispenser or any spray fluid delivery dispenser and the like.

Referring to FIG. 2, in another embodiment of the multiple reservoir apparatus 10, the multiple reservoir apparatus 10 comprises at least one valve 20 coupled to a portion of the multiple reservoir apparatus 10 (two shown in FIG. 2). The at least one valve 20 facilitates flow of at least one of the plurality of fluids (not shown in FIG. 2) at a predetermined rate from each one of the plurality of reservoirs 14 (not shown in FIG. 2) to the spray gun 30 (not shown in FIG. 2). In FIG. 2 a plurality of connectors 18 (two shown in FIG. 2) is coupled to a portion of the fluid conduit 12 and each one of the plurality of connectors 18 is sized to receive each of the plurality of reservoirs 14. In the specific embodiment of FIG. 2, each one of the connectors 18 is a male connector 18.

FIG. 3 is a sectional view through 3-3 of the multiple reservoir apparatus 10 of FIG. 2 showing one valve stem 22 inserted in a portion of the valve 20 coupled to a portion of the fluid conduit 12 having an opening for transportation of at least one of the plurality of fluids (not shown in FIG. 3) from at least one of the plurality of reservoirs 14 (not shown in FIG. 3). It is understood that more than one valve 20 may be coupled to a portion of the fluid conduit 12 or that the valve 20 may be coupled to a portion of the spray gun 30.

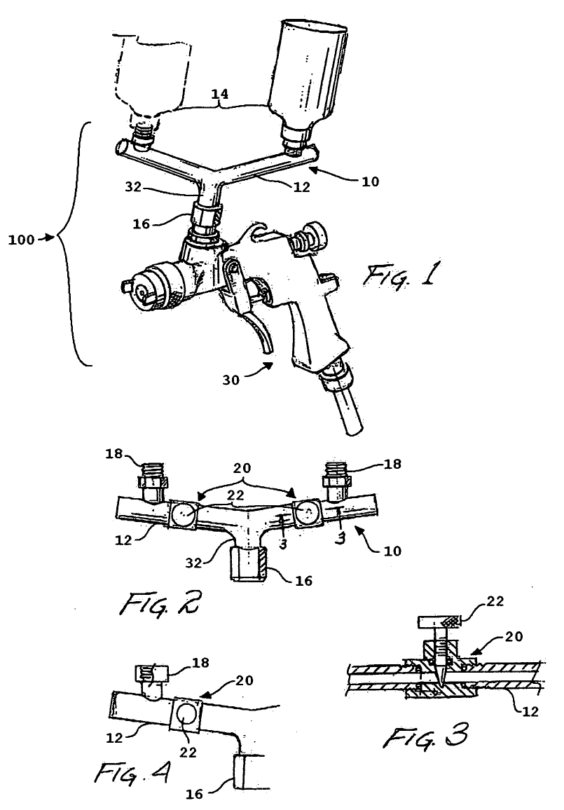

FIG. 4 in an alternative embodiment of a multiple reservoir apparatus 10, one connector 18 is a female connector 18 coupled to a portion of the fluid conduit 12. The female connector 18 receives at least one of a plurality of reservoirs 14 (not shown in FIG. 4). It is understood that both at least one female connector 18 (as shown in FIG. 4) and at least one male connector 18 (as shown in FIG. 2 may be coupled to a portion of the fluid conduit 12.

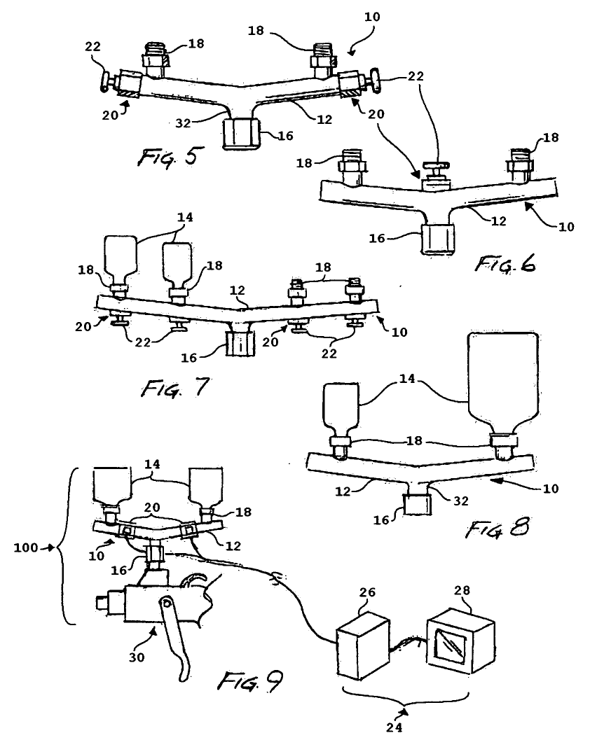

FIG. 5 shows yet another embodiment of a multiple reservoir apparatus 10. The multiple reservoir apparatus 10 (of FIG. 5) comprises the fluid conduit 12 having a first end and a second end. The multiple reservoir apparatus 10 (of FIG. 5) further comprises one valve 20 coupled to a portion of the first end of the fluid conduit 12 and a second valve 20 coupled to the second end of the fluid conduit 12 thereby restricting feed of the fluid (not shown in FIG. 5) from each one of the plurality of reservoirs 14 to the fluid conduit 12. According to this embodiment of the multiple reservoir apparatus 10 (of FIG. 5), two male connectors 18 are each coupled to a portion of the fluid conduit 12 proximate to each one of the ends of the fluid conduit 12. It is understood that any female connector 18 may substitute for any male connector 18 and an adaptor having one female end and one male end may be coupled to any one of a male connector 18 or a female connector 18, thereby providing flexibility of use of the multiple reservoir apparatus 10.

Referring to FIG. 6, in another embodiment of a multiple reservoir apparatus 10, the multiple reservoir apparatus 10 comprises the elongated fluid conduit 12, the spray gun adaptor 16 coupled to the fluid output portion 32 of the fluid conduit 12 for coupling the multiple reservoir apparatus 10 to a portion of the spray gun 30 (not shown in FIG. 6). The multiple reservoir apparatus 10 further comprises two male connectors 18, each one coupled to a portion of the fluid conduit 12. Each one of the male connectors 18 receive one of the plurality of reservoirs 14 (not shown in FIG. 6). One valve 20 is coupled to a portion of the fluid conduit 12 of the multiple reservoir apparatus 10 and the valve 20 is adapted to receive one of the plurality of fluids from one of the plurality of reservoirs 14 (not shown in FIG. 6) and a second one of the plurality of fluids from a second reservoir of the plurality of reservoirs 14 (not shown in FIG. 6). The valve stem 22 of the valve 20 may be adjusted in a variety of ways including, by screwing the valve stem 22, sliding the valve stem 22 in the valve 20 or the like.

FIG. 7 is still another embodiment of a multiple reservoir apparatus 10 comprising a plurality of connectors 18 with each one of the plurality of connectors 18 coupled to a portion of the elongated fluid conduit 12. The multiple reservoir apparatus 10 (of FIG. 7) further comprises a plurality of valves 20 with each one of the plurality of valves 20 coupled to a portion of the elongated fluid conduit 12 proximate to each one of the plurality of connectors 18. Furthermore, the spray gun adaptor 16 is coupled to the fluid output portion 32, which is further coupled to a portion of the elongated fluid conduit 12. Each one of the plurality of connectors 18 is coupled to one of the plurality of reservoirs 14. Each one of the plurality of valves 20 may distribute at least one of the plurality of fluids from each one of the plurality of reservoirs 14 so that either each one of the plurality of fluids or a mixture of the plurality of fluids may be dispensed by the spray gun 30.

FIG. 8 illustrates another embodiment of a multiple reservoir apparatus 10 comprising the spray gun adaptor 16 coupled to the outlet portion 32 of the elongated fluid conduit 12. The spray gun adaptor 16 is coupled to a portion of the spray gun 30. A first connector of the plurality of connectors 18 is coupled to a portion of the elongated fluid conduit 12 and receives a first reservoir of the plurality of reservoirs 14, while a second connector of the plurality of connectors 18 is coupled to a portion of the elongated fluid conduit 12 and receives a larger second reservoir of the plurality of reservoirs 14 (see FIG. 8). The multiple reservoir apparatus 10 (of FIG. 8) permits a person to use various sized reservoirs of the plurality of reservoirs 18. It is understood that at least one valve 20 may be coupled to a portion of the elongated fluid conduit 12 so that at least one of the plurality of fluids may be distributed from each one of the plurality of reservoirs 14.

According to FIG. 9 in yet another embodiment of a combination multiple reservoir and spray gun assembly 100, the combination multiple reservoir and spray gun assembly 100 comprises at least one controller 24 coupled to at least one valve of the multiple reservoir apparatus 10 (FIG. 9 shows one controller 24 and two valves 20). The at least one controller 24 is adapted to automatically feed a predefined quantity of at least one of the plurality of fluids from each one of the plurality of reservoirs 14 (two shown in FIG. 9) to the spray gun 30 at a predetermined flow rate. The controller 24 comprises a data processor 26 and a display 28, although it is understood that the display 28 and the data processor 26 may be a single unit. In all other respects, the combination multiple reservoir and spray gun assembly 100 is similar to the multiple reservoir and spray gun assembly 100 of FIG. 1 (described above). The multiple reservoir apparatus 10 is also similar to any one of the embodiments of the multiple reservoir apparatus 10 described above. The advantage of a controller 24 is that the amount of each fluid of the plurality of fluids distributed from each one of the plurality of reservoirs 14 to the spray gun 30 may be pre-programmed so that a person using the combination multiple reservoir and spray gun assembly 100 need not manually adjust the level of each fluid of the plurality of fluids distributed from each one of the plurality of reservoirs 14. It is understood that, for example, differing shades and tones of paints may be automatically pre-programmed, thereby providing the person with numerous possible variations of paint colors.

In using the multiple reservoir and spray gun assembly 100 a person is provided with the multiple reservoir apparatus 10. The multiple reservoir apparatus 10 comprises a substantially hollow elongated fluid conduit 12 and a plurality of reservoirs 14. Each one of the plurality of reservoirs 14 is coupled in fluid communication to an interior portion of the fluid conduit 12 and the spray gun 30 is coupled to a fluid output portion 32 of the fluid conduit 12. The fluid conduit 12 dispenses a spray fluid. The multiple reservoir apparatus 10 further comprises at least one valve 20 coupled to a portion of the multiple reservoir apparatus 10 so that the at least one valve 20 may facilitate gravity-fed flow of each one of a plurality of fluids at a predetermined rate from each one of the plurality of reservoirs 14 to the spray gun 30. The at least one valve 20 is coupled to a portion of the fluid conduit 12 of the multiple reservoir apparatus 10 and the plurality of connectors 18 is coupled to a portion of the fluid conduit 20. Furthermore, each one of the plurality of connectors 18 is sized to receive one reservoir 14 of the plurality of reservoirs 14. The person using the multiple reservoir and spray gun assembly 100 may adjust each one of the at least one valve 20 and selectively distribute at least one fluid of the plurality of fluids from at least one of the plurality of reservoirs 14 to the fluid conduit 12. Alternatively, the multiple reservoir and spray gun assembly 100 comprises at least one controller 24 coupled to the at least one valve 20 of the multiple reservoir apparatus 10. The at least one controller 24 comprises a processor 26 and a display 28 and the controller 24 is adapted to automatically feed a predefined quantity of at least one of the plurality of fluids from each one of the plurality of reservoirs 14 to the spray gun 30 at a predetermined flow rate.

While the invention has been particularly shown and described with reference to preferred embodiments thereof, it will be understood by those skilled in the art that the foregoing and other changes in form and details may be made therein without departing from the spirit and scope of the invention. For example, the multiple reservoir apparatus may be sized to deliver small and large quantities of fluids. The combination multiple reservoir and spray gun assembly may comprise the multiple spray apparatus directly coupled to the spray gun without the spray gun adaptor. While, gravity feeding of each one of a plurality of fluids from each one of a plurality of reservoirs is preferred, each one of the plurality of fluids may be separately fed from a plurality of remote containers including each one of the plurality of fluids.

1. A combination multiple reservoir and spray gun assembly comprising in combination:
a multiple reservoir apparatus comprising a substantially hollow elongated fluid conduit and a plurality of reservoirs each coupled in fluid communication to an interior portion of said fluid conduit; and
a spray gun coupled to a fluid output portion of said fluid conduit for dispensing a spray fluid.

2. The combination multiple reservoir and spray gun assembly according to claim 1 further comprising at least one valve coupled to a portion of said multiple reservoir apparatus, said at least one valve facilitating flow of said fluid at a predetermined rate from each one of said plurality of reservoirs to said spray gun.

3. The combination multiple reservoir assembly and spray gun assembly according to claim 2 wherein said at least one valve is coupled to a portion of said fluid conduit.

4. The combination multiple reservoir and spray gun assembly according to claim 1 further comprising a plurality of connectors coupled to a portion of said fluid conduit, each one of said plurality of connectors sized to receive one reservoir of said plurality of reservoirs.

5. The combination multiple reservoir and spray gun assembly according to claim 2 further comprising at least one controller, said at least one controller coupled to said at least one valve of said multiple reservoir apparatus, said at least one controller adapted to automatically feed a predefined quantity of at least one of a plurality of fluids from each one of said plurality of reservoirs to said spray gun at a predetermined flow rate.

6. The combination multiple reservoir and spray gun assembly according to claim 5 further comprising a plurality of valves, each one of said plurality of valves coupled to a portion of said fluid conduit and each one of said plurality of valves adjacent to each one of said plurality of reservoirs thereby restricting feed of said fluid from each one of said plurality of reservoirs to said fluid conduit.

7. The combination multiple reservoir and spray gun assembly according to claim 5 further comprising said fluid conduit having a first end and a second end, one of said at least one valve coupled to a portion of said first end of said fluid conduit and a further one of said at least one valve coupled to said second end of said fluid conduit thereby restricting feed of said fluid from each one of said plurality of reservoirs to said fluid conduit.

8. A multiple reservoir apparatus for a spray gun comprising in combination:
a substantially hollow elongated fluid conduit;
a plurality of reservoirs each one of said plurality of reservoirs providing a fluid for gravity feeding said fluid to said fluid conduit; and
said spray gun coupled to a fluid output portion of said fluid conduit for dispensing a spray fluid, said spray gun receiving said fluid that is gravity fed into said fluid conduit from said plurality of reservoirs.

9. The multiple reservoir apparatus according to claim 8 further comprising at least one valve coupled to a portion of said multiple reservoir apparatus, said at least one valve facilitating flow of said fluid at a predetermined rate from each one of said plurality of reservoirs to said spray gun.

10. The multiple reservoir apparatus according to claim 9 wherein said at least one valve is coupled to a portion of said fluid conduit.

11. The multiple reservoir apparatus according to claim 8 further comprising a plurality of connectors coupled to a portion of said fluid conduit, each one of said plurality of connectors sized to receive one reservoir of said plurality of reservoirs.

12. The multiple reservoir apparatus according to claim 9 further comprising at least one controller, said at least one controller coupled to said at least one valve of said multiple reservoir apparatus, said at least one controller adapted to automatically feed a predefined quantity of at least one of a plurality of fluids from each one of said plurality of reservoirs to said spray gun at a predetermined flow rate.

13. The multiple reservoir apparatus according to claim 12 further comprising a plurality of valves, each one of said plurality of valves coupled to a portion of said fluid conduit and each one of said plurality of valves adjacent to each one of said plurality of reservoirs thereby restricting feed of said fluid from each one of said plurality of reservoirs to said fluid conduit.

14. The multiple reservoir apparatus according to claim 12 further comprising said fluid conduit having a first end and a second end, one of said at least one valve coupled to a portion of said first end of said fluid conduit and a further one of said at least one valve coupled to said second end of said fluid conduit thereby restricting feed of said fluid from each one of said plurality of reservoirs to said fluid conduit.

15. A method for using a combination multiple reservoir and spray gun assembly comprising the steps of:
providing a multiple reservoir apparatus comprising a substantially hollow elongated fluid conduit and a plurality of reservoirs, each coupled in fluid communication to an interior portion of said fluid conduit; and
providing a spray gun coupled to a fluid output portion of said fluid conduit, said fluid conduit for dispensing a spray fluid.

16. The method according to claim 15 further comprising the steps of:
providing at least one valve coupled to a portion of said multiple reservoir apparatus, said at least one valve facilitating flow of said fluid at a predetermined rate from each one of said plurality of reservoirs to said spray gun;
providing said at least one valve is coupled to a portion of said fluid conduit; and
providing a plurality of connectors coupled to a portion of said fluid conduit, each one of said plurality of connectors sized to receive one reservoir of said plurality of reservoirs.

17. The method according to claim 16 further comprising the steps of:
adjusting said at least one valve; and
selectively distributing at least one fluid from at least one of said plurality of reservoirs to said fluid conduit.

18. The method according to claim 16 further comprising the steps of:
providing at least one controller, said at least one controller coupled to said at least one valve of said multiple reservoir apparatus; and
adapting said at least one controller to automatically feed a predefined quantity of at least one of a plurality of fluids from each one of said plurality of reservoirs to said spray gun at a predetermined flow rate.
